(19) United States
(12) Patent Application Publication
(10) Pub. No.: US 2019/0315643 A1
(43) Pub. Date: Oct. 17, 2019

(54) METHOD AND APPARATUS FOR BIOLOGICALLY TREATING NITROGEN

(71) Applicant: DOOSAN HEAVY INDUSTRIES & CONSTRUCTION CO., LTD., Changwon-si (KR)

(72) Inventors: Seong Ju Kim, Jinju-si (KR); Hwan Chul Cho, Seoul (KR); Yang Oh Jin, Yonginsi (KR)

(21) Appl. No.: 16/289,678

(22) Filed: Mar. 1, 2019

(30) Foreign Application Priority Data
Apr. 12, 2018 (KR) 10-2018-0042671

(51) Int. Cl. C02F 9/00

(52) U.S. Cl. CPC C02F 9/00; C02F 3/303

(57) ABSTRACT

A method for biologically treating nitrogen while minimizing energy and carbon source usage uses an aerobic tank, a first anoxic tank, and a second anoxic tank. The method includes introducing feed water by dividedly introducing the feed water to the aerobic tank and the first anoxic tank; converting ammonia nitrogen into nitrate nitrogen in the aerobic tank; converting the nitrate nitrogen into nitrite nitrogen through partial denitrification in the first anoxic tank using organic material contained in the feed water; and converting the nitrite nitrogen and ammonia into nitrogen gas in the second anoxic tank using an anammox microorganism. The ammonia nitrogen is converted by determining aeration intensity, aeration time, and/or aeration amount depending on an ammonia concentration in the aerobic tank. The nitrate nitrogen is converted by determining a reaction time of the first anoxic tank based on nitrate and nitrite concentrations in the first anoxic tank.

### CROSS REFERENCE TO RELATED APPLICATIONS

The present application claims priority to Korean Patent Application No. 10-2018-0042671, filed Apr. 12, 2018, which is incorporated herein by reference in its entirety.

### BACKGROUND OF THE DISCLOSURE

### 1. Field of the Disclosure

The present invention relates to a method and apparatus for biologically treating nitrogen, and more particularly to the removal of nitrogen from sewage and wastewater while minimizing energy and carbon source usage.

### 2. Description of the Background Art

The treatment of organic matter has been the main goal to date in water treatment, and the proliferation of systems for treating sewage and wastewater has improved the quality of sewage and wastewater discharged into public waters, yet the concentration of nutrients such as nitrogen or phosphorus is still increasing. Therefore, the treatment of such nutrients as well as organic matter is receiving attention. An advanced water treatment technique, one that is more efficient and economical, is needed to address red tide and eutrophication conditions.

Representative examples of biological nitrogen treatment methods for sewage and wastewater may include removal of nitrogen, by allowing microorganisms to ingest a nitrogen component as a nutrition source, and the use of the nitrogen cycle through nitrification and denitrification of specific microorganism communities. These methods involve assimilating the nitrogen component in wastewater into microorganisms by proliferating microorganisms in a reaction tank. In order to continuously increase the amount of microorganisms in the reaction tank during the treatment, a certain amount of the microorganisms should be removed from time to time. In doing so, a large amount of new waste may be generated, which is undesirable.

The removal of nitrogen is mainly based on biological treatment through combination of nitrification using autotrophic microorganisms and denitrification using heterotrophic microorganisms. Here, nitrification is a process in which autotrophic microorganisms are used to convert ammonia nitrogen (NH₄) into nitrite nitrogen (NO₂) or nitrate nitrogen (NO₃). Oxidizing ammonia into nitrite involves ammonia-oxidizing microorganisms such as Nitrosomonas, Nitrosococcus, or Nitrosobacillus, and oxidizing nitrite into nitric acid involves nitrite-oxidizing microorganisms such as Nitrobacter or Nitrosocystis.

The above nitrification reaction requires oxygen. In order to achieve a highly efficient nitrification reaction, a large amount of nitrification microorganisms must be secured and maintained in the reaction tank. Furthermore, since a large amount of alkali is also required, an alkaline agent or a buffer agent has to be used in order to adjust the pH, which is lowered. Other factors, such as temperature, BOD/N ratio, and ammonia concentration, also affect the nitrification reaction.

Meanwhile, denitrification is a process in which nitrate or nitrite is converted into nitrogen gas (N₂) by heterotrophic microorganisms such as Pseudomonas, Bacillus, or Micrococcus, under anoxic conditions in which dissolved oxygen (DO) does not exist and in which nitrate nitrogen or nitrite nitrogen does exist. The heterotrophic denitrification reaction needs an organic carbon source, serving as an electron donor. When the amount of the organic carbon source is low, an organic carbon source such as methanol has to be added from the outside. As for methanol addition, however, it is difficult to appropriately control the amount of methanol that is added, and the toxicity of methanol itself causes secondary contamination if methanol remains in the treated water.

In this technological field, it is known that the amount of methanol needed is theoretically at least three times as large as the amount of nitrogen to be treated. In practice, the amount is actually three to ten times, specifically about 6.5 times on average.

In particular, since most wastewater having a high nitrogen concentration contains a large amount of ammonia nitrogen, nitrification and denitrification processes have to be performed. When ammonia nitrogen is present at a high concentration, it is difficult to carry out nitrification, and nitrification requires a long processing time and an accompanying source of power for aeration. On the other hand, denitrification requires an organic carbon source. When the amount of the organic carbon source is insufficient, an organic carbon source such as methanol should be added.

Therefore, thorough research into reducing the use of energy and an external carbon source necessary for nitrogen removal is needed.

### SUMMARY OF THE DISCLOSURE

Accordingly, an objective of the present invention is to provide a method and apparatus for biologically removing nitrogen, capable of minimizing the use of energy and an external carbon source.

The objective of the present invention is not limited to the foregoing, and other objectives and advantages of the present invention, which are not mentioned herein, may be understood through the following description.

According to one aspect of the present invention, there is provided a method of biologically treating nitrogen using an apparatus including an aerobic tank, a first anoxic tank, and a second anoxic tank. The method may include steps of introducing feed water; converting ammonia nitrogen into nitrate nitrogen in the aerobic tank; converting the nitrate nitrogen into nitrite nitrogen through partial denitrification in the first anoxic tank using an organic material contained in the feed water; and converting the nitrite nitrogen and ammonia into nitrogen gas in the second anoxic tank using an anammox microorganism.

The feed water may be introduced by dividedly introducing an amount of the feed water to the aerobic tank and an amount of the feed water to the first anoxic tank. Here, 40% to 60% of the feed water may be introduced to the aerobic tank and a remainder of the feed water may be introduced to the first anoxic tank. Alternatively, the method may further include a step of adjusting the amount of the feed water introduced to the aerobic tank and the amount of the feed water introduced to the first anoxic tank, based on at least one of an ammonia concentration in the aerobic tank and concentrations of nitrate and nitrite in the first anoxic tank.

The ammonia nitrogen may be converted into the nitrate nitrogen by determining at least one of an aeration intensity, an aeration time, and an aeration amount depending on an ammonia concentration in the aerobic tank. Here, the method may further include a step of measuring the ammonia concentration using an ammonia (NH₄) sensor provided to the aerobic tank. The aeration intensity may be determined at a starting point in the aerobic tank and at a position immediately before the first anoxic tank, and the aeration intensity determined at the starting point in the aerobic tank and the aeration intensity determined at the position immediately before the first anoxic tank may be different from each other. At least one of the aeration intensity and the aeration amount may be decreased over time.

The nitrate nitrogen may be converted into the nitrite nitrogen by determining a reaction time of the first anoxic tank based on a nitrate concentration and a nitrite concentration in the first anoxic tank. The reaction time of the first anoxic tank may be determined to be less than one hour in order to minimize a proportion of the nitrite nitrogen that is converted into nitrogen gas. The nitrite nitrogen and the ammonia may be converted into the nitrogen gas by determining a reaction time of the second anoxic tank, and the reaction time of the first anoxic tank and the reaction time of the second anoxic tank may be determined so as to be different from each other based on the nitrate concentration and the nitrite concentration.

The ammonia nitrogen and the nitrite nitrogen in the second anoxic tank may be reacted at a molar ratio of 1:1 to 1:3.

According to another aspect of the present invention, there is provided an apparatus for biologically treating nitrogen. The apparatus may include an aerobic tank for converting ammonia nitrogen of feed water into nitrate nitrogen; a first anoxic tank for converting the nitrate nitrogen into nitrite nitrogen; and a second anoxic tank for converting the nitrite nitrogen into nitrogen gas using an anammox microorganism.

The apparatus may further include an ammonia (NH4) sensor provided to the aerobic tank; a nitrate (NO3) sensor and a nitrite (NO2) sensor respectively provided to the first anoxic tank; a feed water line provided so as to be branched to the aerobic tank and to the first anoxic tank; an external carbon source line for supplying an external carbon source to the first anoxic tank; and/or a return line connecting the second anoxic tank and the aerobic tank, wherein the ammonia nitrogen or the nitrite nitrogen is returned to the aerobic tank from the second anoxic tank via the return line. The external carbon source may include at least one selected from among glycerol, methanol, ethanol, and acetic acid, and the second anoxic tank may be a fluidized-bed or a fixed-bed biofilm reactor.

According to the present invention, considering that the conditions under which nitrification and denitrification occur are different, nitrogen can be removed from wastewater using a carbon source contained in wastewater without the additional supply of an external carbon source, thereby minimizing the use of energy and an external carbon source.

### BRIEF DESCRIPTION OF THE DRAWINGS

FIG. 1 is a process diagram showing the principle of a biological denitrification process according to an embodiment of the present invention;

FIG. 2 is schematic diagram showing an apparatus capable of performing a biological denitrification process according to an embodiment of the present invention;

FIG. 3 is a flowchart showing a biological denitrification process according to an embodiment of the present invention; and

FIG. 4 is a diagram showing the application of a biological denitrification process according to an embodiment of the present invention.

### DETAILED DESCRIPTION OF THE DISCLOSURE

Hereinafter, a detailed description will be given of embodiments of the present invention with reference to the appended drawings. The present invention may be embodied in a variety of different forms and is not limited to the embodiments herein.

In order to clearly illustrate the present invention, a description of part not related to the gist of the present invention is omitted, and the same or like elements are denoted by the same reference numerals throughout the specification.

It is also to be understood that when any part is referred to as “comprising” or “including” any element, it does not exclude other elements, but may further include other elements unless otherwise stated. The terminology used herein is for the purpose of describing particular embodiments only and is not intended to limit the present invention, and may be construed as being understood by one of ordinary skill in the art to which the present invention belongs, unless otherwise defined herein.

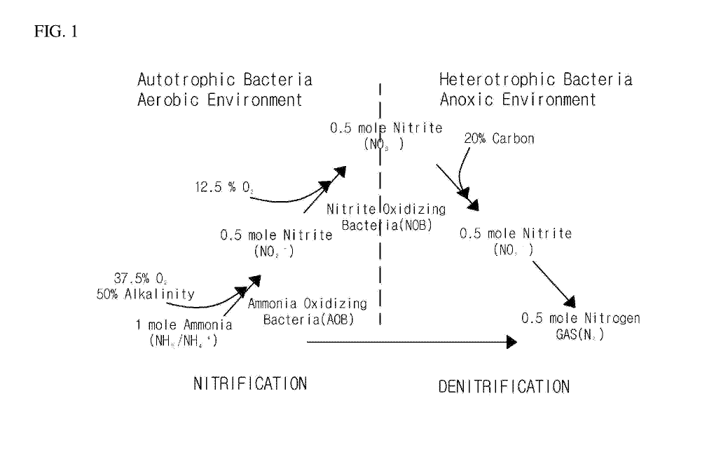

FIG. 1 diagrams the principle of a biological denitrification process according to an embodiment of the present invention.

With reference to FIG. 1, the biological denitrification process according to an embodiment of the present invention is performed in a manner in which 50% of ammonia (NH₄) contained in feed water is converted into nitrate (NO₃), the nitrate (NO₃) is converted into nitrite (NO₂) through partial denitrification using a COD component contained in feed water, and the nitrite (NO₂) and ammonia (NH₄) are ultimately removed in the form of nitrogen (N₂) gas through an anammox process using anammox microorganisms. The anammox process enables nitrite (NO₂), serving as an oxidizing agent, and an ammonium ion (NH₄⁺), serving as a reducing agent, to be converted into nitrogen gas.

A typical process of removing nitrogen from sewage and wastewater includes nitrification under aerobic conditions and denitrification under anoxic conditions, and thus maintenance costs of the process are high. In contrast, an annamox process (anaerobic ammoxidation) is performed using microorganisms that cause anaerobic ammonia oxidation (i.e., ANAMMOX), thus omitting the steps of introducing oxygen and supplying an external carbon source necessary for the existing process of separating nitrogen from wastewater. Hence, the anammox process is advantageous because of short nitrogen removal time and efficient use of treatment site and because an additional external carbon source and oxygen are not required, such that maintenance costs are low.

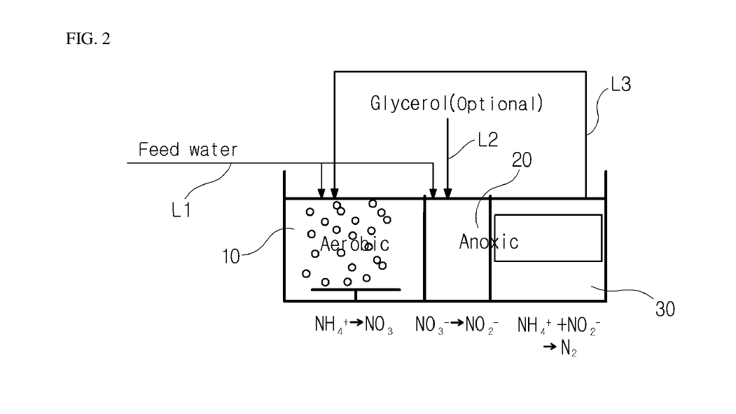

A denitrification apparatus for performing the biological denitrification process according to an embodiment of the present invention is shown in FIG. 2.

With reference to FIG. 2, the biological denitrification apparatus according to an embodiment of the present invention includes an aerobic tank 10, a first anoxic tank 20, and a second anoxic tank 30.

Feed water may be dividedly introduced to each of the aerobic tank 10 and the first anoxic tank 20. Specifically, a feed water line L1 may be provided so as to be branched to the aerobic tank 10 and to the first anoxic tank 20.

The aerobic tank 10 may be provided with an ammonia (NH₄) sensor, and the first anoxic tank 20 may be provided with a nitrate (NO₃) sensor and a nitrite (NO₂) sensor, thus enabling adjustment of the rate of a supply of feed water and adjustment of the aeration intensity. The first anoxic tank 20 may be provided with an external carbon source line L2. The external carbon source, which is supplied to the first anoxic tank through the external carbon source line, may include at least one selected from among glycerol, methanol, ethanol, and acetic acid.

The annamox reaction may be carried out in the second anoxic tank 30. When a fluidized-bed reactor is used as the second anoxic tank 30, it is necessary to maintain a solid retention time (SRT) of forty days or more by separating and recovering the anammox strain using at least one of a disk filter, a screen filter, and a cartridge filter. Hence, a fixed-bed biofilm reactor is preferably used as the second anoxic tank 30, thereby maximizing the denitrification efficiency.

The second anoxic tank 30 and the aerobic tank 10 may be connected to each other via a return line L3. Accordingly, the remaining ammonia nitrogen or nitrite nitrogen may be returned to the aerobic tank 10 from the second anoxic tank 30 via the return line L3 to thus increase the nitrogen removal efficiency.

In some cases, partial denitrification and anammox reactions may be simultaneously carried out by providing the first anoxic tank 20 and the second anoxic tank 30 in the form of a single reaction tank.

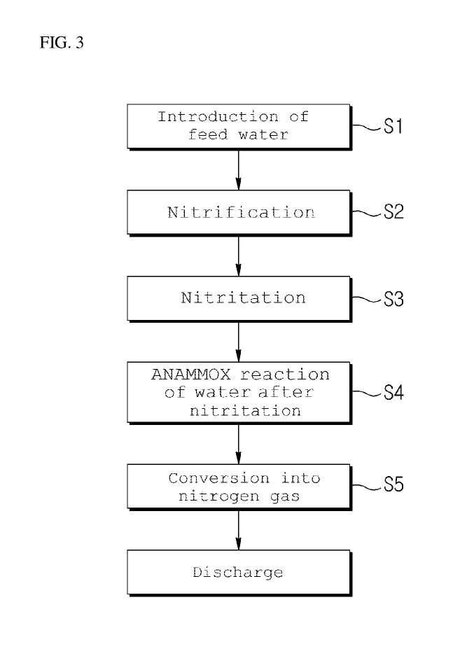

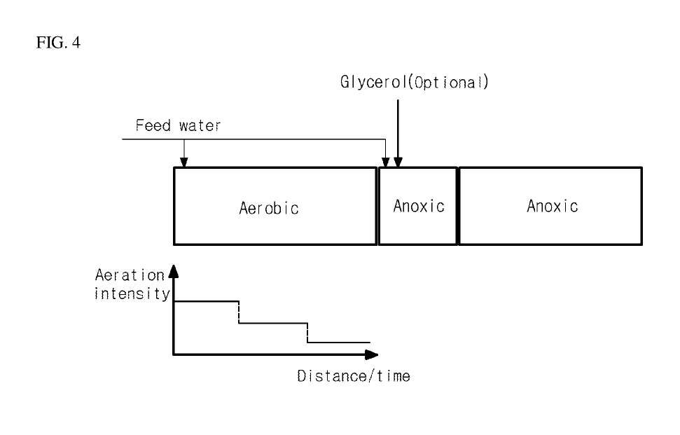

FIG. 3 shows the biological denitrification process according to an embodiment of the present invention, and FIG. 4 shows the application of the biological denitrification process according to an embodiment of the present invention. Here, in the denitrification process according to an embodiment of the present invention, the relationship between the aeration intensity and the aeration time is depicted in FIG. 4.

With reference to FIG. 3, the biological denitrification process according to an embodiment of the present invention includes dividedly introducing feed water to an aerobic tank and a first anoxic tank (S1), converting ammonia nitrogen into nitrate nitrogen in the aerobic tank (S2), converting the nitrate nitrogen (NO₃) into nitrite nitrogen (NO₂) in the first anoxic tank (S3), and converting the nitrite nitrogen (NO₂) into nitrogen gas (N₂) in a second anoxic tank (S4, S5).

The aerobic tank 10 functions to convert the introduced ammonia nitrogen (NH₄) into nitrate (NO₃). Here, the aeration intensity, aeration time, aeration amount, and the like may be determined by the concentration of the ammonia introduced into the aerobic tank 10.

In the aeration process, the aeration intensity at the initial introduction point and the aeration intensity at a position immediately before the first anoxic tank 20 may be different from each other, as shown in FIG. 4. For example, as the time increases in the aerobic tank, the aeration intensity may be lowered incrementally.

For instance, the ammonia nitrogen concentration of feed water in sewage is about 40 mg/L, and variations in this level are inconsequential. Here, when the concentration of ammonia nitrogen increases, the aeration intensity/aeration amount should be increased proportionally to thus completely convert the introduced ammonia nitrogen into nitrate nitrogen in the aerobic tank 10. For example, in the case of using a plug flow reactor for the intensity control at different positions, the concentration of ammonia nitrogen decreases from the initial introduction point toward the first anoxic tank 20. Accordingly, it is preferred that the aeration amount or the aeration intensity be lowered.

The first anoxic tank 20 functions to convert the converted nitrate nitrogen (NO₃) into nitrite nitrogen (NO₂) using the introduced organic material (COD). Specifically, in the first anoxic tank 20, nitrate nitrogen (NO₃) produced in the aerobic tank 10 is subjected to partial denitrification using the organic material (COD) contained in the feed water and is thus converted into nitrite nitrogen (NO₂). Here, the hydraulic retention time (HRT) should be maintained within a short time period, for example, one hour or less, compared to the HRT of the conventional denitrification process, in order to minimize the proportion of the nitrite nitrogen (NO₂) that is converted into nitrogen gas (N₂), and the ammonia nitrogen is maintained as it is.

The second anoxic tank 20 functions such that the nitrite nitrogen (NO₂) and ammonia nitrogen (NH₄) are converted into nitrogen gas (N₂) using anammox microorganisms and thus removed.

Anaerobic ammonium oxidation, commonly abbreviated as anammox, is a reaction using ammonia (NH₄±) and nitrite (NO₂) as substrates under anaerobic conditions and using anammox bacteria as autotrophic bacteria that synthesize cells from inorganic carbon.

Since the anammox reaction is an autotrophic reaction in which nitrogen gas is generated using NH₄⁺ as an electron donor and NO₂⁻ as an electron acceptor under anaerobic conditions, the supply of oxygen for nitrification and an organic carbon source for denitrification may be minimized, thus making it possible to drastically reduce treatment costs.

In order to remove the nitrogen component through the anammox reaction, ammonia nitrogen (NH₄) and nitrite nitrogen (NO₂) have to be present at a molar ratio of 1:1 to 1:3 in the feed water to be treated.

However, ammonia nitrogen (NH₄) is present in most of the feed water to be treated, and thus about 50% has to be converted into nitrite nitrogen (NO₂).

To this end, a partial denitrification process is required. This partial denitrification technique may be achieved by controlling the reaction for converting nitrite nitrogen into nitrate nitrogen during nitrification in the existing nitrification-denitrification process.

After the anammox reaction, nitrate nitrogen (NO₃) is generated in an amount of about 10% of the fed nitrogen, and nitrite nitrogen (NO₂) remaining after the reaction is contained in the treated water.

However, ammonia-oxidizing bacteria (Nitrosomonas) for nitritation and anammox bacteria for anammox reaction are very slow to grow, and it is not easy to dominantly culture anammox bacteria in the reaction tank. These bacteria, which are autotrophic bacteria, are difficult to culture to a high concentration due to their slow growth rate, thus making them difficult to actually apply to sewage and wastewater treatment plants.

In order to commercialize the nitrogen removal technology using nitritation and anammox, it is most important that ammonia-oxidizing bacteria (nitrite bacteria) and anammox bacteria be stably maintained in a predetermined amount in the reaction tank.

Furthermore, the conventional nitrogen treatment process using partial nitritation and anammox is problematic in that the remaining nitrite nitrogen and nitrate nitrogen may be left behind in the final effluent.

Therefore, when nitrate nitrogen and nitrite nitrogen contained in the treated water are removed through denitrification into nitrogen gas, in lieu of using an organic carbon source such as methanol, nitrogen removal efficiency may be further increased.

According to the aforementioned embodiment of the present invention, energy may be saved by decreasing the extent of the aerobic reaction, and partial denitrification is performed using the organic material of the feed water, thereby reducing the supply and cost of an additional external carbon source such as glycerol, methanol, ethanol, acetic acid, or the like.

Also, when the reaction in the anoxic tank (partial denitrification+anammox) is carried out two or more times after the reaction time in the aerobic tank, the nitrogen removal efficiency may be maximized.

Of the initial feed water, the amount of feed water introduced to the aerobic tank is maintained in the range of 40% to 60%, and the overall amount of feed water introduced to the anoxic tank is maintained in the range of 60% to 40%.

The feed water introduced to the anoxic tank is continuously/repeatedly subjected to “partial denitrification (NO₃→NO₂)+anammox” two or more times, thereby maximizing the nitrogen removal efficiency. Here, each reaction time of “first anoxic tank+second anoxic tank” is different.

In the first anoxic tank for converting nitrate nitrogen (NO₃) into nitrite nitrogen (NO₂), when HRT increases, conversion of nitrite nitrogen (NO₂) into nitrogen gas (N₂) occurs and thus HRT has to be maintained as short as possible. In the second anoxic tank for converting the converted nitrite nitrogen (NO₂) and ammonia nitrogen (NH₄) into nitrogen gas (N₂) through the anammox reaction, HRT has to be maintained long. This HRT may vary depending on the microorganism concentration in each reaction tank and the concentration of each type of nitrogen. As such, operation control may be implemented through the NO₂/NO₃ sensors.

Since it is difficult to completely convert nitrate nitrogen (NO₃) only into nitrite nitrogen (NO₂) upon partial denitrification using the organic material (COD) of the feed water in the first anoxic tank, primary operation is performed at the time point at which nitrate nitrogen (NO₃) is most effectively converted into nitrite nitrogen (NO₂), for example, for a time period of thirty to sixty minutes. As such, glycerol may be supplied to the first anoxic tank if necessary.

Thereafter, the nitrate nitrogen (NO₃), remaining after the reaction in the aerobic tank, and ammonia nitrogen (NH₄), remaining after conversion into nitrite nitrogen (NO₂), are subjected to deammonification through the anammox reaction.

The greatest advantage of this method is that the use of the organic material in the step of removing nitrogen by converting nitrite nitrogen (NO₂) into nitrogen gas (N₂) may be reduced and the nitrogen removal efficiency may be maximized.

Although preferred embodiments of the present invention have been disclosed for illustrative purposes, those skilled in the art will appreciate that diverse variations and modifications are possible through addition, alteration, deletion, etc. of elements, without departing from the spirit and scope of the invention. Thus, the above embodiments should be understood not to be limiting but to be illustrative.

The scope of the invention is represented by the claims below rather than the aforementioned detailed description, and all of the changes or modified forms that are capable of being derived from the meaning, range, and equivalent concepts of the appended claims should be construed as being included in the scope of the present invention.

What is claimed is:

1. A method of biologically treating nitrogen using an apparatus comprising an aerobic tank, a first anoxic tank, and a second anoxic tank, the method comprising:
introducing feed water;
converting ammonia nitrogen into nitrate nitrogen in the aerobic tank;
converting the nitrate nitrogen into nitrite nitrogen through partial denitrification in the first anoxic tank using an organic material contained in the feed water; and
converting the nitrite nitrogen and ammonia into nitrogen gas in the second anoxic tank using an anammox microorganism.

2. The method of claim 1, wherein the feed water is introduced by dividedly introducing an amount of the feed water to the aerobic tank and an amount of the feed water to the first anoxic tank.

3. The method of claim 2, wherein 40% to 60% of the feed water is introduced to the aerobic tank and a remainder of the feed water is introduced to the first anoxic tank.

4. The method of claim 2, further comprising:
adjusting the amount of the feed water introduced to the aerobic tank and the amount of the feed water introduced to the first anoxic tank, based on at least one of an ammonia concentration in the aerobic tank and concentrations of nitrate and nitrite in the first anoxic tank.

5. The method of claim 1, wherein the ammonia nitrogen is converted into the nitrate nitrogen by determining at least one of an aeration intensity, an aeration time, and an aeration amount depending on an ammonia concentration in the aerobic tank.

6. The method of claim 5, further comprising:
measuring the ammonia concentration using an ammonia (NH₄) sensor provided to the aerobic tank.

7. The method of claim 5, wherein the aeration intensity is determined at a starting point in the aerobic tank and at a position immediately before the first anoxic tank, and wherein the aeration intensity determined at the starting point in the aerobic tank and the aeration intensity determined at the position immediately before the first anoxic tank are different from each other.

8. The method of claim 5, wherein at least one of the aeration intensity and the aeration amount is decreased over time.

9. The method of claim 1, wherein the nitrate nitrogen is converted into the nitrite nitrogen by determining a reaction time of the first anoxic tank based on a nitrate concentration and a nitrite concentration in the first anoxic tank.

10. The method of claim 9, wherein the reaction time of the first anoxic tank is determined to be less than one hour in order to minimize a proportion of the nitrite nitrogen that is converted into nitrogen gas.

11. The method of claim 9, wherein the nitrite nitrogen and the ammonia are converted into the nitrogen gas by determining a reaction time of the second anoxic tank, and wherein the reaction time of the first anoxic tank and the reaction time of the second anoxic tank are determined so as to be different from each other based on the nitrate concentration and the nitrite concentration.

12. The method of claim 1, wherein the ammonia nitrogen and the nitrite nitrogen in the second anoxic tank are reacted at a molar ratio of 1:1 to 1:3.

13. An apparatus for biologically treating nitrogen, the apparatus comprising:
an aerobic tank for converting ammonia nitrogen of feed water into nitrate nitrogen;
a first anoxic tank for converting the nitrate nitrogen into nitrite nitrogen; and
a second anoxic tank for converting the nitrite nitrogen into nitrogen gas using an anammox microorganism.

14. The apparatus of claim 13, further comprising an ammonia (NH₄) sensor provided to the aerobic tank.

15. The apparatus of claim 13, further comprising a nitrate (NO₃) sensor and a nitrite (NO₂) sensor respectively provided to the first anoxic tank.

16. The apparatus of claim 13, further comprising a feed water line provided so as to be branched to the aerobic tank and to the first anoxic tank.

17. The apparatus of claim 13, further comprising an external carbon source line for supplying an external carbon source to the first anoxic tank.

18. The apparatus of claim 17, wherein the external carbon source includes at least one selected from among glycerol, methanol, ethanol, and acetic acid.

19. The apparatus of claim 13, wherein the second anoxic tank is one of a fluidized-bed and a fixed-bed biofilm reactor.

20. The apparatus of claim 13, further comprising a return line connecting the second anoxic tank and the aerobic tank,
wherein the ammonia nitrogen or the nitrite nitrogen is returned to the aerobic tank from the second anoxic tank via the return line.
